(19) United States
(12) Patent Application Publication
(10) Pub. No.: US 2003/0054277 A1
(43) Pub. Date: Mar. 20, 2003

(54) Developing agent

(75) Inventor: Yukihiro Fujikura, Kawasaki-shi (JP)

Correspondence Address: Johnny A. Kumar, FOLEY & LARDNER, Washington Harbour, 3000 K Street, N.W., Suite 500, Washington, DC, 20007-5109, US

(73) Assignee: TOSHIBA TEC KABUSHIKI KAISHA

(21) Appl. No.: 09/932,960

(22) Filed: Aug. 21, 2001

(51) Int. Cl. G03G 9/09

(52) U.S. Cl. 430/108.1; 430/108.6; 430/137.1; 430/137.2

(57) ABSTRACT

Disclosed is a developing agent including toner particles containing a phosphorescent pigment and a binder resin, in the case of using the developing agent, printing capable of temporality storing light and emitting light even under a dark place can be easily formed by the electrophotographic system.

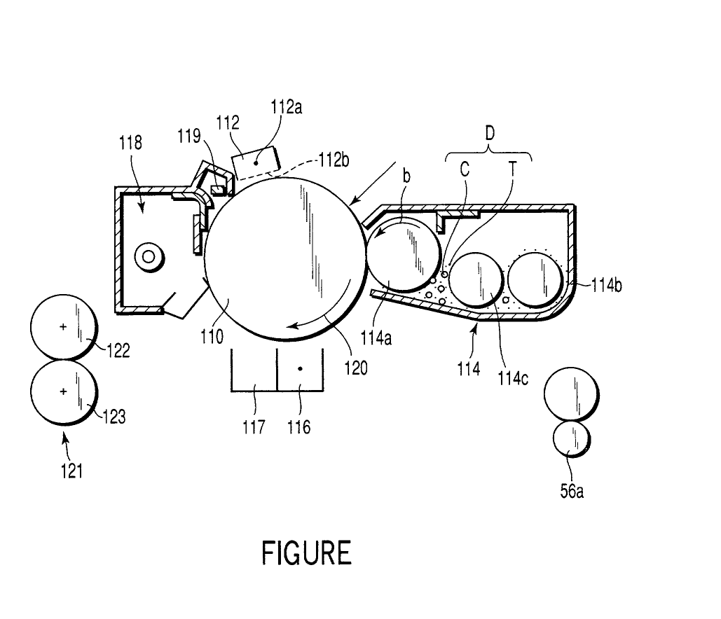

### BACKGROUND OF THE INVENTION

The present invention relates to a developing agent containing a phosphorescent pigment, particularly, to a developing agent used for the preparation of a printed matter, e.g., a map, a meeting document, a poster or a calender, which has long persistent phosphorescence and emits light in a dark place, and applicable to a copying machine including an electro-photographic copying machine, a printer and a facsimile.

The phosphorescent pigment is a pigment using a phosphor capable of temporarily trapping light energy and emitting light and is featured in that the afterglow is long. The phosphor used in the phosphorescent pigment is disclosed in, for example, Jpn. Pat. Appln. KOKAI Publication No. 7-11250.

The phosphorescent pigment is used preferably for display for enhancing safety, such as direction signs, guide displays, safety marks, fire extinguisher trigger displays, switches, stairway steps, stairway corners, road construction cones, and chains for attracting attention. The phosphorescent pigment is also used for toys, fishing tools, stationery and decorative articles.

The phosphorescent pigment is used mainly in the case where the phosphorescent pigment is compounded with a paint so as to prepare a phosphorescent paint, where the phosphorescent pigment is compounded with an ink so as to prepare a phosphorescent ink, and where the phosphorescent pigment is blended with a synthetic resin for the molding of the resin. Where a printed matter is obtained, it was customary to use a phosphorescent ink in, for example, the printing system such as a gravure printing system.

The phosphorescent ink can be prepared by kneading a mixture comprising a phosphorescent pigment having an average particle diameter of, for example, 10 to 80 μm, a resin such as an epoxy resin, a silicone resin, an acrylic resin or an urethane resin, and a solvent, and the phosphorescent ink has in general a viscosity ranging between about 1 cP and about 100,000 cP. If the average diameter of the phosphorescent pigment used for preparation of a phosphorescent ink is smaller than 10 nm, the phosphorescent pigment tends to fail to emit a sufficient amount of light.

In the printing system using the particular ink, a printing plate of a desired image is formed and the ink is disposed on the printing plate. The printing is performed by transferring the ink on the printing plate onto the surface of a medium such as a paper sheet. In such a system, it is possible to easily obtain a large amount of high quality printed matter.

However, in the printing system described above, it is necessary to prepare a printing plate for each image. Therefore, where a large amount of a printed matter is not formed, the printing is rendered highly costly because of the working process required for preparing the printing plate and the material used.

Under the circumstances, it is of high importance to develop an image forming technology that permits obtaining a small amount of a printed matter with a high accuracy and low cost.

### BRIEF SUMMARY OF THE INVENTION

A first object of the present invention, which has been achieved in view of the situation described above, is to provide a developing agent that permits obtaining an image containing a phosphorescent pigment with a high accuracy and low cost.

A second object of the present invention is to provide a method of easily manufacturing a developing agent, that permits obtaining an image containing a phosphorescent pigment with a high accuracy and low cost.

Further, a third object of the present invention is to provide an image forming apparatus that permits obtaining an image containing a phosphorescent pigment with a high accuracy and low cost.

A developing agent comprises toner particles containing a phosphorescent pigment and a binder resin.

A method of manufacturing a developing agent comprises the steps of:

melting and kneading a toner particle material containing a phosphorescent pigment and a binder resin so as to obtain a kneaded material; and

pulverizing and classifying the resultant kneaded material so as to obtain toner particles.

Further, an image forming apparatus, comprises:

at least one image carrier;

a developing device and a transfer device arranged apart from each other to face the image carrier, the developing device housing a developing agent including toner particles containing a phosphorescent pigment and a binder resin and serving to develop an electrostatic latent image formed on the image carrier so as to form a developing agent image, and the transfer device serving to transfer the developing agent image onto a transfer material; and

a fixing device including a heating member and serving to fix the developing agent image transferred onto the transfer material.

According to the present invention, the image formation containing a phosphorescent pigment can be performed by an electrophotographic system. As a result, the obtained image has a high precision, and the image forming cost can be lowered regardless of the number of sheets of the image formed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawing, which is incorporated in and constitutes a part of the specification, illustrates presently preferred embodiments of the invention, and together with the general description given above and the detailed description of the preferred embodiments given below, serve to explain the principles of the present invention.

The single FIGURE shows as an example the construction of an image forming apparatus of the present invention.

### DETAILED DESCRIPTION OF THE INVENTION

The present inventors have conducted extensive research in an attempt to realize an image formation with a high accuracy and low cost by employing an electrophotographic system for formation of an image containing a phosphorescent pigment.

The developing agent of the present invention comprises toner particles containing a phosphorescent pigment and a binder resin.

The image forming apparatus of the present invention to which the developing agent of the present invention can be applied comprises, for example, an image carrier; a developing device arranged to face the image carrier, containing a developing agent including toner particles containing a phosphorescent pigment and a binder resin, and serving to develop an electrostatic latent image formed on the image carrier so as to form a developing agent image; a transfer device for transferring the developing agent image onto a transfer material; and a fixing device including a heating member and serving to fix the developing agent image transferred onto the transfer material.

Also, the image forming method using the image forming apparatus of the present invention comprises the steps of, for example, forming an electrostatic latent image on the image carrier; developing the electrostatic latent image with a developing agent including toner particles containing a phosphorescent pigment and a binder resin so as to form a developing agent image; transferring the developing agent image onto a transfer material; and fixing the developing agent image transferred onto the transfer material.

The phosphorescent materials used as the phosphorescent pigment refer to phosphors having a long afterglow. The afterglow of the phosphorescent material falls within a range of between about 10 minutes and about 500 minutes. If the phosphorescent pigment is used in an article, the light emission is continued so as to enable the user to distinguish the article even where, for example, an outdoor lamp has been turned off or the brightness of the lamp has been lowered in the night.

According to the present invention, the image formation can be achieved by an electrophotographic system by using a developing agent containing such a phosphorescent pigment. It follows that an image containing a phosphorescent pigment can be formed with a high accuracy at a low cost without requiring the printing plate as used in the usual printing system.

It is possible for the developing agent of the present invention to further contain a desired coloring agent.

It is desirable for the binder resin used in the present invention to have a number average molecular weight Mn shown by 2,000≦Mn≦5,000, a weight average molecular weight Mw shown by 8,000≦Mw≦70,000, and a ratio Mw/Mn of the weight average molecular weight Mw to the number average molecular weight Mn shown by 1.6≦Mw/Mn≦35.

If the number average molecular weight Mn of the binder resin is smaller than 2,000, or if the weight average molecular weight Mw of the binder resin is smaller than 8,000, the offset generation temperature is lowered. On the other hand, if the number average molecular weight Mn of the binder resin is larger than 6,000, or if the weight average molecular weight Mw of the binder resin is larger than 70,000, the softening temperature tends to be increased so as to bring about a defective fixation. Also, the ratio Mw/Mn is smaller than 1.6, a high temperature offset is generated. On the other hand, if the ratio Mw/Mn exceeds 36, the transparency tends to be rendered poor so as to bring about a defective fixation.

The binder resin can be synthesized by, for example, a solution polymerization, a bulk polymerization, a suspension polymerization or an emulsion polymerization. It is desirable for the binder resin to be a thermoplastic resin.

The thermoplastic resin used in the present invention includes, for example, polyester, polystyrene, polyvinyl toluene, styrene-butadiene copolymer resin, styrene-acrylic acid ester copolymer, styrene-maleic anhydride copolymer resin, acrylic resin, xylene resin, ionomer resin, ketone resin, terpene resin, phenol-modified terpene resin, rosin, rosin-modified resin, maleic acid-modified phenolic resin, petroleum series resin, starch graft polymer resin, polyvinyl alcohol and polyvinyl pyrrolidone.

Further, the copolymer between styrene and a substituent, which can be used in the present invention, includes, for example, polystyrene homopolymer, hydrgen-added styrene resin, styrene-isobutylene copolymer, acrylonitrile-butadiene-styrene terpolymer, acrylonitrile-styrene-acrylic acid ester terpolymer, acrylonitrile-acrylic rubber-styrene terpolymer, acrylonitrile-chlorinated polystyrene-styrene terpolymer, acrylonitrile-EVA-styrene terpolymer, styrene-p-chlorostyrene copolymer, styrene-propylene copolymer, styrene-butadiene rubber copolymer, styrene-maleic acid ester copolymer and styrene-isobutylene copolymer.

The acrylic based resin used in the present invention includes, for example, polyacrylate, polymethyl methacrylate, polyethyl methacrylate, poly-n-butyl methacrylate, polyglycidyl methacrylate, poly-fluorine-containing acrylate, styrene-methacrylate copolymer, styrene-butyl methacrylate copolymer, and styrene-ethyl acrylate copolymer.

It is desirable to use a polyester resin as a color toner. In order to improve the toner characteristics, it is possible for the glycol component and/or the dicarboxylic acid component of the polyester resin to be substituted by a trivalent or tetravalent alcohols (such as sorbitol, hexatetrol, dipentaerythritol, glycerol and sugar), and/or a trivalent or tetravalent carboxylic acid (such as benzene tricarboxylic acid, cyclohexane tricarboxylic acid, naphthalene tricarboxylic acid, butane tricarboxylic acid, trimellitic acid, and pyromellitic acid) so as to allow the polyester resin to have a partial three dimensional crosslinked structure. It is also possible to introduce an epoxy group or an urethane bond into the polyester resin so as to allow the polyester resin to have a partial crosslinked structure or a graft structure.

The dicarboxylic acid component used for the manufacture of the polyester resin used in the present invention includes, for example, maleic acid, fumaric acid, mesaconic acid, citraconic acid, itaconic acid, glutaconic acid, phthalic acid, isophthalic acid, terephthalic acid, cyclohexane dicarboxylic acid, succinic acid, adipic acid, sebacic acid, malonic acid, linoleic acid, and acid anhydrides thereof and lower alcohol esters thereof. On the other hand, the glycol component of the polyester resin includes, for example, ethylene glycol, propylene glycol, butylene glycol, neopentyl glycol, hexane diol, diethylene glycol, triethylene glycol, polyethylene glycol, dimethylol benzene, cyclohexane dimethanol, bisphenol A and hydrogenated bisphenol A.

The phosphorescent pigment used in the developing agent of the present invention includes, for example, a zinc sulfide based phosphorescent pigment and an aluminate chloride based phosphorescent pigment. The zinc sulfide based phosphorescent pigment includes, for example, a zinc sulfide in which copper is bonded as an activating agent. On the other hand, the aluminate chloride based phosphorescent pigment includes, for example, strontium aluminate, strontium aluminate strontium aluminate, in which a rare earth metal is bonded as an activating agent and calcium aluminate in which a rare earth metal bonded as an activating agent. The rare earth metal noted above includes, for example, europium, dysprosium, and neodymium. These phosphorescent pigments can be used singly or in the form of a mixture of a plurality of these pigments.

Specific examples of the phosphorescent pigment include, for example, Sr₂Al₆O₁₁, Sr₂Al6O₁₀OH, Sr₂Al2O₄, Sr₂Al8O₁₁, SrAl₂O₄:Eu,Dy, Sr₄Al₁₄O₂₅:Eu,Dy, CaAl₂O₄:Eu,Nd, and ZnS:Cu.

It is possible to add the phosphorescent pigment in an amount of 0.5 to 50% by weight, preferably about 5 to 20% by weight, to the binder resin. If the amount of the phosphorescent pigment is smaller than 0.5% by weight, the phosphorescent effect tends to be low. If the amount exceeds 60% by weight, however, the resistance against rubbing tends to be lowered so as to render the fixing properties (smear properties) poor.

It is preferable for the phosphorescent pigment used in the developing agent of the present invention to have a particle diameter falling within a range of between 0.01 μm and 9.0 μm, more preferably between 0.05 μm and 7.0 μm. If the particle diameter is smaller than 0.05 μm, the phosphorescent effect tends to be low. Also, if the particle diameter is larger than 7.0 μm, the phosphorescent pigment tends to be separated from within the toner particle.

Also, if the particle diameter of the phosphorescent pigment falls within a range of between 0.05 μm and 4.5 μm, the transparency is improved. However, the brightness of the emitted light tends to be lowered. On the other hand, if the particle diameter falls within a range of between 4.5 μm and 7.0 μm, it is possible to obtain a sufficiently high brightness of the emitted light, though the transparency tends to be not sufficient.

The method of the present invention for manufacturing a developing agent comprises the steps of melting and kneading a toner particle material containing a binder resin and a phosphorescent pigment, and pulverizing and classifying the resultant kneaded mixture so as to form toner particles.

It is possible to mix various additives with the toner particle. These additives can be mixed in the melting and kneading step, as required.

In the method of the present invention for manufacturing a developing agent, it is possible to use a master batch as a part of the toner particle material. The master batch can be obtained by melting and kneading a mixture containing a phosphorescent pigment and a partial amount of the binder resin. In this case, the binder resin is used in an amount large enough to disperse sufficiently the phosphorescent pigment.

In general, a particulate material such as a coloring agent is dispersed in a binder resin in manufacturing a developing agent. If the particulate material is directly mixed in a large amount of the binder resin, it is difficult to disperse sufficiently the particulate material in the binder resin. Therefore, a master batch is prepared by sufficiently dispersing the coloring agent in a suitable amount of the binder resin, and the remaining binder resin is added to the master batch thus prepared, followed by melting and kneading the resultant mixture. In this case, the coloring agent can be easily dispersed sufficiently in the binder resin.

Similarly, when it comes to the developing agent of the present invention, the phosphorescent pigment can be dispersed sufficiently in the case of preparing and using a master batch. The preparation of the master batch produces an additional effect that the particles of the phosphorescent pigment can be made finer. The phosphorescent pigment mixed in a high concentration in the binder resin receives a high pressure in the melting-kneading step, e.g., during treatment in a pressurizing kneader or a three-roll mill, so as to be made finer into a desired particle diameter.

It is possible to preliminarily mix the toner particle material and the master batch material. As the means for the preliminary mixing, it is possible to use, for example, a ball mill, a V-shaped mixer, a folberg, or a Henschel mixer.

In the melting-kneading step, it is possible to employ a wet dispersion method using a high speed dissolver, a roll mill or a ball mill or a melting-kneading method using a roll, a pressurizing kneader, an internal mixer, or a screw type extruder.

As a means for roughly pulverizing the toner particle, it is possible to use, for example, a hammer mill, a cutter mill, a roller mill or a ball mill. On the other hand, it is possible to use, for example, a jet mill or a high speed rotation type pulverizer as the means of finely pulverizing the roughly pulverized material.

Further, it is possible to use an air stream type classifying machine as the means for classifying the finely pulverized material.

Still further, in order to mix additives such as a silica fine particle and a metal oxide fine particle with the toner particle thus obtained, it is possible to use a high speed rotation mixer such as a Henschel mixer. The additives can be mixed simultaneously or independently depending on the kind of the additive and can be mixed under the conditions that permit producing the most prominent effect.

The coloring agent used in the developing agent of the present invention includes, for example, a carbon black, and organic or inorganic pigment or dye. The carbon black used in the present invention, which is not particularly limited, includes, for example, acetylene black, furnace black, thermal black, channel black and Ketchen black. The pigment and dye used in the present invention include, for example, fast yellow G, benzidine yellow, indofast orange, irugazine red, carmine FB, permanent Bordeaux FRR, pigment orange R, lithol red, lake red C, rhodamine FB, rhodamine B lake, phthalocyanine blue, pigment blue, brilliant green B, phthalocyanine green, quinacridone, benzimidazolon yellow, nigrosine dye, aniline blue, chalco oil blue, chrome yellow, ultramarine blue, Du Pont oil red, monoazo series pigment, disazo series pigment, diallyl series pigment, quinoline yellow, methylene blue chloride, malachite green oxalate, lamp black, and rose Bengal. These carbon black, pigments and dyes can be used singly or in the form of a mixture of a plurality of these materials.

It is possible to add a wax to the binder resin in order to prevent the offset. The wax can be added in the melting-kneading step or in the step of polymerizing the binder resin. The wax used in the present invention includes a synthetic wax, a natural wax and a petroleum wax. The synthetic wax used in the present invention includes, for example, a low molecular weight polyethylene wax, a low molecular weight polypropylene wax, a synthetic fatty acid ester, and a fatty acid bis amide wax. The natural wax used in the present invention includes, for example, a rice wax, a carnauba wax, candelilla wax, Japan wax, beeswax, lanolin, and montan wax. Further, the petroleum wax used in the present invention includes, for example, a paraffin wax, a micro wax and petrolatum.

These waxes can be used singly or in the form of a mixture of a plurality of these waxes.

It is desirable to add the wax in an amount of 1 to 15% by weight, preferably 2 to 6% by weight, based on the total weight of the binder resin. If the mixing amount of the wax falls within the range noted above, the wax plays the role of a lubricating oil in the heat roll temperature so as to prevent the offset and to improve the fixing rate. If the addition amount of the wax is smaller than 1% by weight, it tends to be impossible to obtain a sufficient effect of preventing the offset and to obtain desired fixing properties. On the other hand, if the wax addition amount exceeds 15% by weight, the developing agent tends to invite deterioration of the preservation characteristics, deterioration of the flowability, and deterioration of the life characteristics.

It is also possible for the developing agent of the present invention to contain various charge control agents. Particularly, a colorless charge control agent CCA produces the merits that the light emission from the phosphorescent pigment is not inhibited and that, when used in a color toner, the color tone of the coloring agent is not impaired. The charge control agent CCA of the negative charging properties includes, for example, E-84 (trade name of a salicylic acid derivative-zinc complex manufactured by Orient Chemical K.K.), TN-105 (trade name of a salicylic acid derivative-zirconia complex manufactured by Hodogaya Kagaku K.K.), LR-147 (trade name of a boron complex manufactured by Nippon Carlit K.K.), and FAC-1001N (trade name of styrene-sulfonic acid based resin manufactured by Fijikura Kasei K.K.). On the other hand, the charge control agent CCA of positive charging properties includes, for example, P-51 (trade name of a quaternary ammonium salt manufactured by Orient Chemical K.K.), TP-415 (trade name of a quaternary ammonium salt manufactured by Hodogaya Kagaku K.K.), and FCA-201PB (trade name of a styrene-acryl quaternary ammonium salt based resin manufactured by Fujikura Kasei K.K.).

The addition amount of the charge control agent can preferably fall within a range of between 0.5 and 5% by weight, more preferably between 0.3 and 2% by weight, based on the total weight of the developing agent.

Further, when it comes to the monochromatic toner, it is possible to use additional charge control agents CCA other than the colorless charge control agents CCA described above. For example, it is possible to use metal complex salts of monoazo dyes, metal complex of salicylic acid, oxynaphthoic acid, dicarboxylic acid with such as Co, Cr, Fe and Al, sulfonated copper phthalocyanine, styrene oligomer having a nitro group and halogen introduced therein, chlorinated paraffin and melamine resin as CCA for a monochrome toner.

Also, in the developing agent of the present invention, it is possible to use a silica fine powder as an additive. The additive can be mixed with, for example, the toner particle containing a binder resin and a phosphorescent material.

The fine silica powder used in the present invention includes, for example, silicon dioxide, aluminum silicate, sodium silicate, zinc silicate, and magnesium silicate.

It is possible for the fine silica powder to be surface-treated with a treating agent capable of reaction with or physical adsorption on the fine silica powder such as a silane coupling agent, a silicone varnish, a silicone oil, an organic silicon compound, and a substance having a functional group.

The specific surface treating agents used in the present invention include, for example, hexamethyl disilazane, trimethyl silane, trimethyl chlorosilane, trimethyl ethoxy silane, dimethyl dichlorosilane, methyl trichlorosilane, allyl dimethyl chlorosilane, ally phenyl dichlorosilane, benzyl dimethyl chlorosilane, bromomethyl dimethyl chlorosilane, α-chloroethyl trichlorosilane, β-chloroethyl trichlorosilane, chloromethyl dimethyl chlorosilane, triorgano silyl mercaptan, trimethyl silyl mercaptan, triorgano silyl acrylate, vinyl dimethyl acetoxy silane, dimethyl ethoxy silane, dimethyl dimethoxy silane, diphenyl diethoxy silane, aminopropyl trimethoxy silane, aminopropyl triethoxy silane, dimethyl amino propyl trimethoxy silane, diethyl aminopropyl trimethoxy silane, dipropyl aminopropyl trimethoxy silane, dibutyl aminopropyl trimethoxy silane, monobutyl aminopropyl trimethoxy silane, dibutyl aminopropyl dimethyl monomethoxy silane, dimethyl aminophenyl triethoxy silane, trimethoxy silyl-γ-propyl phenyl amine, trimethoxy silyl-γ-propyl benzyl amine, trimethoxy silyl-γ-propyl piperidine, trimethoxy silyl-γ-propyl morpholine, trimethoxy silyl-γ-propyl imidazole, hexamethyl disiloxane, 1,3-divinyl tetramethyl disiloxane, and 1,3-diphenyl tetramethyl disiloxane.

If the primary particle diameter of the fine silica powder is smaller than 5 nm, the fine silica powder tends to be severely agglomerated so as to form a large structure. Therefore, even if the fine silica powder is added, it tends to be difficult to improve sufficiently the flowability of the toner before the pulverization. On the other hand, if the primary particle diameter of the fine silica powder exceeds 30 nm, it tends to be difficult to improve sufficiently the flowability. It is preferable for the addition amount of the fine silica powder to fall within a range of between 0.1 and 10% by weight, more preferably between 1.0 and 5.0% by weight based on the total weight of the developing agent. If the addition amount is smaller than 0.1% by weight, the flowability of the toner before the pulverization tends to be lowered. On the other hand, if the addition amount exceeds 10% by weight, the surface coverage of the toner after the fine pulverization is rendered excessive so as to tend to make the charging amount of the developing agent nonuniform.

Also, in the developing agent of the present invention, it is possible to use a metal oxide fine particle as an additive. It is possible for the additive to be mixed with the toner particles containing, for example, a binder resin and a phosphorescent material. The metal oxide fine particles used in the present invention include, for example, fine particles of zinc oxide, titanium oxide, aluminum oxide, zirconium oxide, strontium titanate, barium titanate, and zinc stearate.

The image forming apparatus of the present invention, in which the developing agent of the present invention can be used, will now be described with reference to the accompanying FIGURE.

As shown in the FIGURE, a developing device 114 is arranged to face an image carrier, or photoreceptor drum, 110 that is arranged rotatable. The photoreceptor drum 110 is rotated by a main motor (not shown) in the direction denoted by an arrow 120. An electrostatic latent image corresponding to the image information to be recorded is formed on the surface of the photoreceptor drum 110 by a laser beam emitted from a laser exposure apparatus mounted separately.

Arranged along the outer surface of the photoreceptor drum 110 in the rotating direction of the photoreceptor drum 110 denoted by the arrow 120 are a charging device 112 for charging the photoreceptor drum 110 to a predetermined potential, the developing device 114 for developing the electrostatic latent image formed on the surface of the photoreceptor drum 110 by the laser exposure apparatus arranged separately by supplying a toner to the electrostatic latent image noted above, a transfer device 116 for transferring the toner image formed on the photoreceptor drum 110 by the developing device 114 onto a paper sheet, a cleaning device 118 for scratching off the residual toner remaining on the surface of the photoreceptor drum 110, and a discharging device 119 for removing the electric charge remaining on the surface of the photoreceptor drum 110.

The accompanying FIGURE shows that the discharging device 119 is formed integral with the housing of the cleaning device 118. However, it is possible to arrange the discharging device 119 separately. It is also possible to arrange a toner discharging device 117 for facilitating the cleaning of the residual toner between the cleaning device 118 and the transfer device 116. Further, it is possible to arrange separately a discharging device (not shown) between the developing device 114 and the transfer device 116 in order to facilitate the transfer of the toner image onto the paper sheet.

The cleaning device 118 includes a drum holding section for supporting the photoreceptor drum 110 when the photoreceptor drum 110 is mounted to the image forming apparatus 1 and, thus, can also be utilized as a drum holding member.

The charging device 112 includes a corona wire 112a and a grid screen 112b, which are connected to a high voltage circuit (not shown) and a grid bias voltage generating device (not shown) so as to charge the surface of the photoreceptor drum 110 to a predetermined surface potential.

A phosphorescent toner T containing a binder resin and a phosphorescent pigment is housed in the developing device 114. By using a developing agent D prepared by mixing the toner T with a magnetic carrier C covered with an insulating resin, a magnetic brush is formed on a developing roller 114a supporting the developing agent D. The magnetic brush thus formed is brought into contact with the photoreceptor drum 110 arranged to face the developing roller 114a so as to develop the electrostatic latent image formed on the surface of the photoreceptor drum 110. Incidentally, the developing agent D and the developing roller 114a are housed in a housing 114b. Guide rollers 114c for maintaining constant the distance between the surface of the nonmagnetic sleeve forming the outer circumferential surface of the developing roller 114a and the photosensitive layer on the surface of the photoreceptor drum 110 are formed at both edge portions in the longitudinal direction of the developing roller 114a. For maintaining constant the distance noted above, it is also possible to use the bonding or coating of a material having a predetermined thickness or to provide the edge portion of the photoreceptor drum with a bonding or coating of a material having a predetermined thickness in addition to the arrangement of the guide roller 114c noted above. As a result, the distance between the sleeve surface of the developing roller 114a and the photosensitive layer of the photoreceptor drum 110 can be maintained constant.

Incidentally, a magnet medium having a plurality of fixed magnets of S-poles and N-poles arranged in the circumferential direction at predetermined angles is arranged in the developing sleeve of the developing roller 114a.

The electrostatic latent image formed on the surface of the photoreceptor drum 110 is developed as follows. Specifically, the toner attached by the force of mirror image to the ear of the carrier formed on the sleeve along the line of magnetic force generated from the main pole of the magnet medium of the developing roller 114a is moved into a developing region, in which the photoreceptor drum 110 faces the developing roller 114a, by the electric field formed by the potential of the electrostatic latent image formed on the photoreceptor drum 110 and the developing bias voltage. As a result, the electrostatic latent image is developed so as to form a developing agent image.

The developing agent image thus formed is transferred by the transfer device 116 onto a transfer material such as a paper sheet. The transfer material having the developing agent image transferred thereonto is transferred into a fixing device 121 including a heat roller 122 and a pressurizing roller 123 so as to have the developing agent image fixed to the transfer material.

The present invention will now be described more in detail with reference to Examples of the present invention which follow.

### EXAMPLE 1

In the first step, a master batch material of the composition given below was prepared in order to prepare a master batch effective for decreasing the particle diameter of the phosphorescent pigment.

Composition of Mater Batch Material:

| | |
|---|---|
| Polyester resin (Mn = 3500, Mw = 13,000, | . . . 50 parts by weight |
| Mw/Mn = 3.71) | |
| Phosphorescent pigment (strontium aluminate; | . . . 50 parts by weight |
| afterglow of 60 minutes) | |

The master batch material given above was kneaded for 40 minutes in a pressurizing kneader. The kneaded material was passed 5 times through a three-roll mill so as to obtain a master batch of phosphorescent pigment with particle diameters between 0.05 to 7.0 μm and a pigment concentration of 30%.

Composition of Toner Material 1:

| | |
|---|---|
| Polyester resin (Mn = 3500, Mw = 13,000, | . . . 65 parts by weight |
| Mw/Mn = 3.71) | |
| Master batch (containing 50% of strontium | . . . 30 parts by weight |
| aluminate) | |
| Rice wax | . . . 4 parts by weight |
| Salicylic acid derivative-zirconia complex CCA | . . . 1 part by weight |

Toner material 1 of the composition given above was kneaded for 30 minutes in a pressurizing kneader. The kneaded material thus obtained was cooled and roughly pulverized in a hammer mill, followed by finely pulverizing the roughly pulverized material to obtain a finely pulverized material having a particle diameter of 8 μm and classifying the finely pulverized material by using a jet mill and a wind classifying machine, thereby obtaining toner particles.

Then, 0.4 part by weight of a hydrophobic silica was added to 100 parts by weight of the toner particles thus prepared and mixed for 3 minutes in a Henschel mixer, followed by sieving the mixture in a sieve of 200 meshes so as to obtain a phosphorescent toner. Further, 9 parts by weight of the phosphorescent toner was mixed with 91 parts by weight of a ferrite carrier so as to prepare a developing agent.

Copying was performed by using the developing agent thus prepared in a copying machine Premarju 251 manufactured by Toshiba Corporation, Japan, and the copy was evaluated as follows.

Specifically, the copy was irradiated for 3 minutes with a black light (40W, irradiating distance of 20 cm) and the brightness (cd/m²) was measured one minute later. Bm-5A (view field of 2°) manufactured by Topcon Inc. was used as the brightness meter. It should be noted that the brightness higher than 0.002 cd/m² can be recognized by the naked eye, and it is difficult to recognize the brightness lower than 0.001 cd/m². The results are shown in Table 1.

### EXAMPLE 2

A developing agent was prepared as in Example 1, except that used was toner material 2 of the composition given below in place of toner material 1 used in Example 1.

Composition of Toner Material 2:

| | |
|---|---|
| Polyester resin | . . . 54 parts by weight |
| Master batch (containing 50% of strontium | . . . 40 parts by weight |
| aluminate) | |
| Carbon | . . . 1 part by weight |
| Rice wax | . . . 4 parts by weight |
| Salicylic acid derivative-zirconia complex CCA | . . . 1 part by weight |

The obtained developing agent was evaluated as in Example 1. Table 1 also shows the results.

### EXAMPLE 3

A developing agent was prepared as in Example 1, except that used was toner material 3 of the composition given below in place of toner material 1 used in Example 1.

Composition of Toner Material 3:

| | |
|---|---|
| Polyester resin | . . . 50 parts by weight |
| Master batch (containing 50% of strontium | . . . 40 parts by weight |
| aluminate) | |
| Azo series magenta pigment | . . . 5 parts by weight |
| Rice wax | . . . 4 parts by weight |
| Salicylic acid derivative-zirconia complex CCA | . . . 1 part by weight |

The obtained developing agent was evaluated as in Example 1. Table 1 also shows the results.

### EXAMPLE 4

A developing agent was prepared as in Example 1, except that used was toner material 4 of the composition given below in place of toner material 1 used in Example 1.

Composition of Toner Material 4:

| | |
|---|---|
| Polyester resin | . . . 50 parts by weight |
| Master batch (containing 50% of strontium | . . . 40 parts by weight |
| aluminate) | |
| Phthalocyanine series cyan pigment | . . . 5 part by weight |
| Rice wax | . . . 4 parts by weight |
| Salicylic acid derivative-zirconia complex CCA | . . . 1 part by weight |

The obtained developing agent was evaluated as in Example 1. Table 1 also shows the results.

### EXAMPLE 5

A developing agent was prepared as in Example 1, except that used was toner material 5 of the composition given below in place of toner material 1 used in Example 1.

Composition of Toner Material 5:

| | |
|---|---|
| Polyester resin | . . . 50 parts by weight |
| Master batch (containing 50% of strontium | . . . 40 parts by weight |
| aluminate) | |
| Benzimidazolon yellow pigment | . . . 5 part by weight |
| Rice wax | . . . 4 parts by weight |
| Salicylic acid derivative-zirconia complex CCA | . . . 1 part by weight |

A phosphorescent toner was prepared as in Example 1 by using the toner material of the composition given above. The obtained toner was evaluated as in Example 1. Table 1 also shows the results.

### EXAMPLE 6

Color copying was performed by using the developing agents of four colors, which were prepared in Examples 2 to 5. A copying machine Premarju 251 manufactured by Toshiba Corporation was used for the copying. The formed color copy was evaluated as in Example 1. Table 1 also shows the results.

### EXAMPLE 7

Toner material 6 of the composition given below was prepared.

Composition of Toner Material 6:

| | |
|---|---|
| Polyester resin (Mn = 6,000, Mw = 80,000, | . . . 94.6 parts by weight |
| Mw/Mn = 13.3) | |
| Strontium aluminate (afterglow of 1 minute) | . . . 0.4 parts by weight |
| Rice wax | . . . 4 parts by weight |
| Salicylic acid derivative-zirconia complex CCA | . . . 1 part by weight |

Toner material 6 of the composition given above was kneaded for 30 minutes in a pressurizing kneader. The kneaded material thus obtained was cooled and roughly pulverized in a hammer mill, followed by finely pulverizing the roughly pulverized material to obtain a finely pulverized material having a particle diameter of 8 μm and classifying the finely pulverized material by using a jet mill and a wind classifying machine, thereby obtaining toner particles.

Then, 0.4 part by weight of a hydrophobic silica was added to 100 parts by weight of the toner particles thus prepared and mixed for 3 minutes in a Henschel mixer, followed by sieving the mixture in a sieve of 200 meshes so as to obtain a phosphorescent toner. Further, 9 parts by weight of the phosphorescent toner was mixed with 91 parts by weight of a ferrite carrier so as to prepare a developing agent.

Copying was performed by using the developing agent thus obtained and the formed copy was evaluated as in Example 1. Table 1 also shows the results.

### EAXMPLE 8

Toner material 7 of the composition given below was prepared.

Composition of Toner Material 7:

| | |
|---|---|
| Polyester resin (Mn = 6,000, Mw = 80,000, | . . . 39 parts by weight |
| Mw/Mn = 13.3) | |
| Strontium aluminate | . . . 51 parts by weight |
| Azo series magenta pigment | . . . 5 parts by weight |
| Rice wax | . . . 4 parts by weight |
| Salicylic acid derivative-zirconia complex CCA | . . . 1 part by weight |

A developing agent was prepared as in Example 7 by using the toner material of the composition given above. The toner thus obtained was evaluated as in Example 1. Table 1 also shows the results.

TABLE 1

| | Brightness | | Fixing | |
|---|---|---|---|---|
| | (cd/m²) | Recognition | properties | Judgment |
| Example 1 | 0.0702 | ◯ | ◯ | ◯ |
| Example 2 | 0.0912 | ◯ | ◯ | ◯ |
| Example 3 | 0.1152 | ◯ | ◯ | ◯ |
| Example 4 | 0.1031 | ◯ | ◯ | ◯ |
| Example 5 | 0.1568 | ◯ | ◯ | ◯ |
| Example 6 | 0.0812 | ◯ | ◯ | ◯ |
| Example 7 | 0.0008 | | | Δ |
| Example 8 | 0.1847 | ◯ | X | Δ |

The developing agent of the present invention contains a phosphorescent pigment and, thus, is capable of emitting light even in a dark place. However, if the addition amount of the phosphorescent pigment is not larger than 0.5% by weight as in Example 7, the brightness tends to be unduly low as apparent from Table 1. Also, if the binder resin has a number average molecular weight Mn exceeding 5,000 and a weight average molecular weight exceeding 70,000 as in Example 8, the fixing properties of the developing agent tend to be rendered poor.

What is claimed is:

1. A developing agent comprising toner particles containing a phosphorescent pigment and a binder resin.

2. The developing agent according to claim 1, further containing a coloring agent.

3. The developing agent according to claim 1, wherein said binder resin has a number average molecular weight Mn falling within a range of between 2,000 and 5,000, a weight average molecular weight Mw falling within a range of between 8,000 and 70,000, and a ratio Mw/Mn of the weight average molecular weight Mw to the number average molecular weight Mn falling within a range of between 1.6 and 35.

4. The developing agent according to claim 1, further containing a wax.

5. The developing agent according to claim 4, wherein at least a part of said wax is mixed in the step of polymerizing said binder resin.

6. The developing agent according to claim 1, wherein said phosphorescent pigment has an average particle diameter falling within a range of between 0.01 μm and 9.0 μm.

7. The developing agent according to claim 1, wherein said toner particle is prepared by forming first a master batch by melting and kneading a mixture consisting of said phosphorescent pigment and one part amount of said binder resin, followed by mixing the other part amount of said binder resin with the master batch and subsequently drying and classifying the mixture.

8. A method of manufacturing a developing agent, comprising the steps of:
melting and kneading a toner particle material containing a phosphorescent pigment and a binder resin to obtain a kneaded material; and
pulverizing and classifying the resultant kneaded material to obtain toner particles.

9. The method of manufacturing a developing agent according to claim 8, wherein a master batch is formed by melting and kneading in advance a mixture consisting of said phosphorescent pigment and a part amount of said binder resin, followed by mixing the other part amount of said binder resin with the master batch and subsequently melting and kneading the mixture to obtain a kneaded mixture.

10. The method of manufacturing a developing agent according to claim 8, wherein said toner particle material further contains a coloring agent.

11. The method of manufacturing a developing agent according to claim 8, wherein said binder resin has a number average molecular weight Mn falling within a range of between 2,000 and 5,000, a weight average molecular weight Mw falling within a range of between 8,000 and 70,000, and a ratio Mw/Mn of the weight average molecular weight Mw to the number average molecular weight Mn falling within a range of between 1.6 and 35.

12. The method of manufacturing a developing agent according to claim 8, wherein said toner particle material further contains a wax.

13. The method of manufacturing a developing agent according to claim 12, wherein at least a part of said wax is mixed in the step of polymerizing said binder resin.

14. The method of manufacturing a developing agent according to claim 8, wherein said phosphorescent pigment has an average particle diameter falling within a range of between 0.01 μm and 9.0 μm.

15. An image forming apparatus, comprising:
at least one image carrier;
a developing device arranged apart from each other to face said image carrier, housing a developing agent including toner particles containing a phosphorescent pigment and a binder resin and to develop an electrostatic latent image formed on the image carrier to form a developing agent image;
a transfer device to transfer said developing agent image onto a transfer material; and
a fixing device including a heating member and serving to fix the developing agent image transferred onto the transfer material.

16. The image forming apparatus according to claim 15, wherein said developing agent further contains a coloring agent.

17. The image forming apparatus according to claim 15, wherein said binder resin has a number average molecular weight Mn falling within a range of between 2,000 and 5,000, a weight average molecular weight Mw falling within a range of between 8,000 and 70,000, and a ratio Mw/Mn of the weight average molecular weight Mw to the number average molecular weight Mn falling within a range of between 1.6 and 35.

18. The image forming apparatus according to claim 15, wherein said developing agent further contains a wax.

19. The image forming apparatus according to claim 18, wherein at least a part of said wax is mixed in the step of polymerizing said binder resin.

20. The image forming apparatus according to claim 15, wherein said phosphorescent pigment has an average particle diameter falling within a range of between 0.01 μm and 9.0 μm.

21. The image forming apparatus according to claim 15, wherein said toner particle is prepared by forming a master batch by melting and kneading a mixture consisting of said phosphorescent pigment and one part amount of said binder resin, followed by mixing the other part amount of said binder resin with the resultant master batch and subsequently drying and classifying the mixture.
